(19) United States
(12) Patent Application Publication
(10) Pub. No.: US 2020/0294084 A1
(43) Pub. Date: Sep. 17, 2020

(54) DYNAMIC MARKETING CAMPAIGN TARGETING

(71) Applicant: HEWLETT PACKARD ENTERPRISE DEVELOPMENT LP, Houston, TX (US)

(72) Inventors: Shripal Gandhi, Bangalore (IN); Dies P. Varghese, Bangalore (IN); Sandra I. Flores Nazario, Aguadilla, PR (US); Vishruth Muthyala, Bangalore (IN)

(21) Appl. No.: 16/515,940

(22) Filed: Jul. 18, 2019

Related U.S. Application Data
(60) Provisional application No. 62/812,093, filed on Mar. 15, 2019.

(51) Int. Cl. G06Q 30/02; G06Q 10/06; G06F 16/26; G06F 16/23

(52) U.S. Cl. CPC G06Q 30/0244; G06Q 10/067; G06F 2216/03; G06F 16/2393; G06F 16/26

(57) ABSTRACT

Systems and methods are provided for dynamic marketing campaign targeting. One of the methods may include identifying a plurality of business intelligence data sources, wherein the business intelligence data sources are separate and diverse; creating data tables in a database management system from the plurality of business intelligence data sources; creating a unified data model from the data tables; receiving a business intelligence request; and responsive to the business intelligence request: generating one or more predictive analytics based on the unified data model, and displaying a view of the one or more predictive analytics.

### CROSS REFERENCE TO RELATED APPLICATION

The present application claims priority to U.S. Provisional Patent Application No. 62/812,093, filed Mar. 15, 2019, entitled “Dynamic Campaign Targeting—A Self-Service Business Intelligence and Analytics Solution,” the disclosure thereof incorporated by reference herein in its entirety.

### DESCRIPTION OF RELATED ART

The disclosed technology relates generally to data communication networks, and more particularly some embodiments relate to managing network devices in such networks.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a system for dynamic campaign targeting according to embodiments of the disclosed technology.

FIG. 2 is a block diagram of an example computing component or device for dynamic campaign targeting in accordance with one embodiment.

FIG. 3 shows an example business intelligence request according to embodiments of the disclosed technology.

FIG. 4 shows an example predictive analytics view according to embodiments of the disclosed technology.

FIG. 5 depicts a block diagram of an example computer system in which embodiments described herein may be implemented.

The figures are not exhaustive and do not limit the present disclosure to the precise form disclosed.

### DETAILED DESCRIPTION

To guide targeted marketing campaigns, customer and marketing insights teams employ vast amounts of account-related data. But today this data exists only in isolated silos. Teams scattered around a company use different databases and tools for business intelligence reporting and analysis that target separate use cases. There is no central repository of data and tools for customer-related data across marketing, sales, operations and finance organizations. The only options for these teams are disparate tools and their informal networks to find the data needed to prepare for campaign targeting. Accordingly a great deal of work is involved in cleaning, slicing, dicing and consolidating all this data to design a targeted marketing campaign. Sometimes this process takes several weeks. But targeted campaigns are most effective when launched in a timely manner.

Big Data represents another challenge. The amount of data to be processed is now so great that, it is difficult to load the data into the databases, perform the needed computations, and share the resulting account lists with users. This process also involves much redundancy, as teams have to work on the same kind of campaign targeting requests again and again.

Disclosed is a self-service computer-implemented business intelligence and analytics platform. The computer-implemented platform creates optimized data tables in a database management system from myriad business intelligence data sources, and unifies those optimized data tables in a single unified data model. This unification employs computer technology to overcome a problem specifically arising in the realm of computer technology, by unifying the various business intelligence data sources and databases required by a targeted campaign into a single data model that can be easily queried to obtain immediate results in the form of predictive analytics that can be put to immediate use. Based on the unified data model and user-supplied criteria, the computer-implemented platform quickly generates predictive analytics, and displays those predictive analytics in a computer-implemented data visualization system that makes these predictive analytics easy to understand, manipulate, and leverage into a targeted campaign design. For example, the computer-implemented platform can quickly recommend particular customer accounts, together with “propensity to buy” rankings and the like. Thanks to the unified model and its computer implementation, these predictive analytics may be generated almost instantaneously, as opposed to the days or weeks required by conventional processes. This timelines of these predictive analytics provides the resulting targeted campaigns with a significant edge over competitors.

It should be noted that the terms “optimize,” “optimized,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

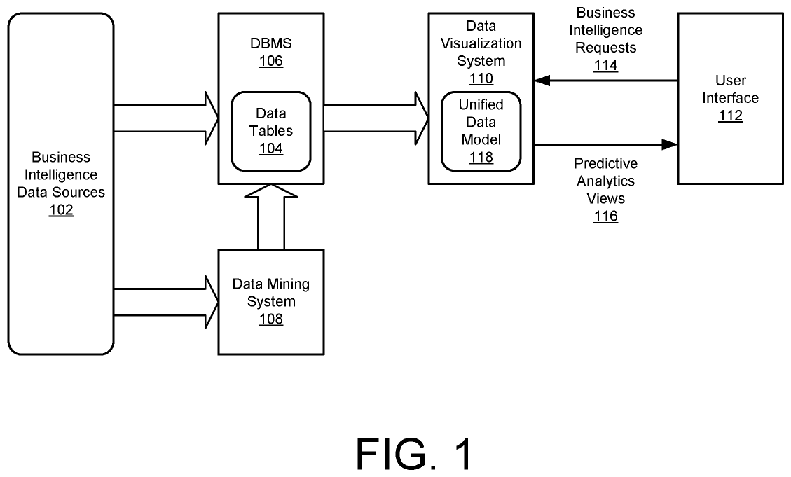

FIG. 1 illustrates a system for dynamic campaign targeting according to embodiments of the disclosed technology. Referring to FIG. 1, the system draws on numerous business intelligence data sources 102. The business intelligence data sources 102 may include assets such as account revenue details, customer install base, competitor install base, win-loss deals, visits to company websites, and the like.

The system of FIG. 1 may include a database management system (DBMS) 106. In some implementations, the DBMS 106 may be implemented as an HP Vertica system. The DBMS 106 may include data tables 104. The data tables 104 be drawn from the numerous business intelligence data sources 102. The data tables 104 may be optimized.

The data tables 104 may be refreshed from the business intelligence data sources 102. For example, the data tables 104 may be refreshed by a data mining system 108. In some implementations, the data mining system 108 may be implemented as a data science software platform. The data tables 104 may be refreshed occasionally or periodically, for example on a daily or weekly basis.

The system of FIG. 1 may include a data visualization system 110. In some implementations, the data visualization system 110 may be implemented as a Qlik Sense system. The data visualization system 110 may include a unified data model 118. The unified data model 118 may be created from the data tables 104 in the DBMS 106.

The system of FIG. 1 may include a user interface 112. The user interface 112 may be employed by users to submit business intelligence requests 114 to the data visualization system 110. The user interface 112 may be employed by users to receive predictive analytics views generated by the data visualization system 110. The data visualization system 110 may generate the predictive analytics views 116 based on the unified data model 118 and the business intelligence requests 114.

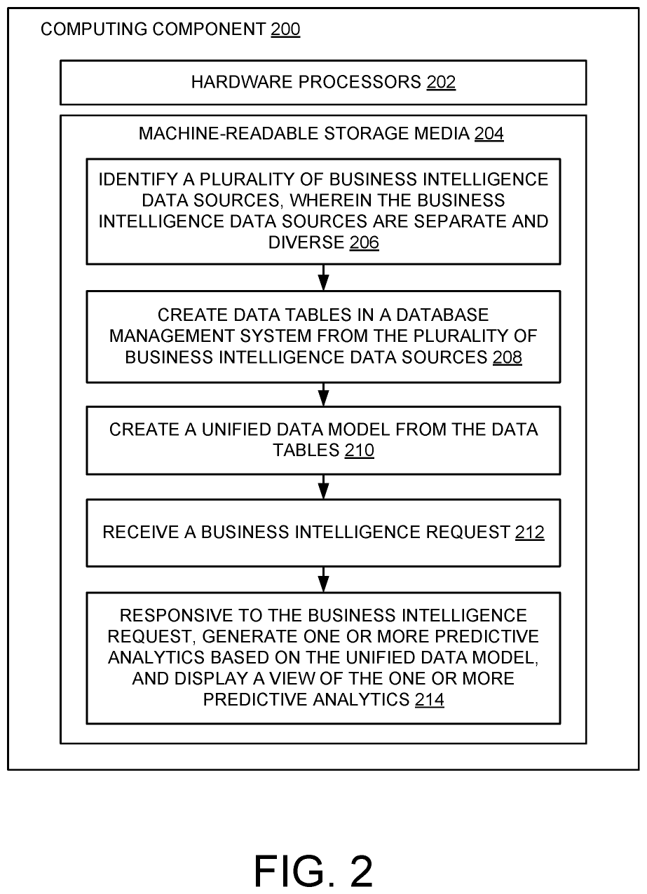

FIG. 2 is a block diagram of an example computing component or device 200 for dynamic campaign targeting in accordance with one embodiment. Computing component 200 may be, for example, a server computer, a controller, or any other similar computing component capable of processing data. In the example implementation of FIG. 2, the computing component 200 includes a hardware processor 202, and machine-readable storage medium 204.

Hardware processor 202 may be one or more central processing units (CPUs), semiconductor-based microprocessors, and/or other hardware devices suitable for retrieval and execution of instructions stored in machine-readable storage medium, 204. Hardware processor 202 may fetch, decode, and execute instructions, such as instructions 206-214, to control processes or operations for dynamic campaign targeting. As an alternative or in addition to retrieving and executing instructions, hardware processor 202 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 204, may be any electronic, magnetic, optical, or other physical storage device that contains or stores executable instructions. Thus, machine-readable storage medium 204 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 204 may be a non-transitory storage medium, where the term “non-transitory” does not encompass transitory propagating signals. As described in detail below, machine-readable storage medium 204 may be encoded with executable instructions, for example, instructions 206-214. Depending on the implementation, the instructions may include additional, fewer, or alternative instructions performed in various orders or in parallel.

Hardware processor 202 may execute instruction 206 to identify a plurality of business intelligence data sources. The business intelligence data sources may be separate, diverse, or both. Business intelligence data sources may be separate when the sources are different. For example, the business intelligence data sources may be provided by different vendors. Business intelligence data sources may be diverse when the business intelligence data sources provide data describing different types of business intelligence. For example, the business intelligence data sources may describe different industry segments. In some embodiments, the business intelligence data sources 102 of FIG. 1 may be identified by a user employing the user interface 112. In some embodiments, the business intelligence data sources 102 may be identified by a system administrator.

Hardware processor 202 may execute instruction 208 to create data tables in a database management system from the plurality of business intelligence data sources. The example of FIG. 1, the data tables 104 may be created in the DBMS 106 from the business intelligence data sources 102.

Hardware processor 202 may execute instruction 210 to create a computer-implemented unified data model from the data tables. As described above, a problem arising with current computer-implemented approaches is that the required business intelligence data sources are separate and diverse. To use these data sources one must query each one separately, and then integrate the results. Disclosed embodiments may be configured to solve these problems, which themselves arise in the realm of computer technology, and the manner in which that computer technology is currently implemented. The disclosed embodiments provide a solution to these problems by unifying these separate and diverse business intelligence sources in a computer-implemented unified data model that may be accessed by computer to provide understandable and actionable insights through computer-generated predictive analytics. In the example of FIG. 1, the unified data model 118 may be created in the data visualization system 110 from the data tables 104 of the DBMS 106. As mentioned above, in some embodiments, the data visualization system 110 may be implemented as a Qlik Sense system. In such embodiments, Qlik QVD files may be created from the data tables 104, and the Qlik Sense system may fetch the QVD files.

Furthermore, in such embodiments, the QVD files may be refreshed automatically, occasionally or periodically. For example, the QVD files may be refreshed on a daily or weekly basis. The data tables 104 may be refreshed occasionally or periodically by the data mining system 108. A Qlik Sense app may be created and used to refresh the QVD files. One advantage of using the QVD files is that reading data from such files is generally 10-100 times faster than reading from other data sources. Embodiments of this approach may be implemented so that the unified data model is created and updated automatically by the computer system, in contrast to conventional approaches where multiple different data sources must be analyzed, and the results painstakingly integrated. Embodiments may also be configured to enable the computer system to create and maintain the model very quickly (e.g., within a matter of seconds or minutes), eliminating the days or weeks required by conventional approaches.

Hardware processor 202 may execute instruction 212 to receive a business intelligence request. In the example of FIG. 1, a user may employ the user interface 112 to submit a business intelligence request 114. The business intelligence request 114 is received by the data visualization system 110. For example, the business intelligence request 114 may include one or more filters specified by the user. An example business intelligence request 114 may be to identify customers who have purchased a particular product that expires in a particular year, and who have a high propensity to buy.

Hardware processor 202 may execute instruction 214 to generate one or more predictive analytics based on the unified data model, and display a view of the one or more predictive analytics, responsive to the business intelligence request. In the example of FIG. 1, the predictive analytics views 116 may be generated by the data visualization system 110, and provided to the user interface 112 for display. With the disclosed computer-implemented unified data model, it is unnecessary to query multiple databases, and to integrate the various results. Instead, the disclosed predictive analytics are available immediately.

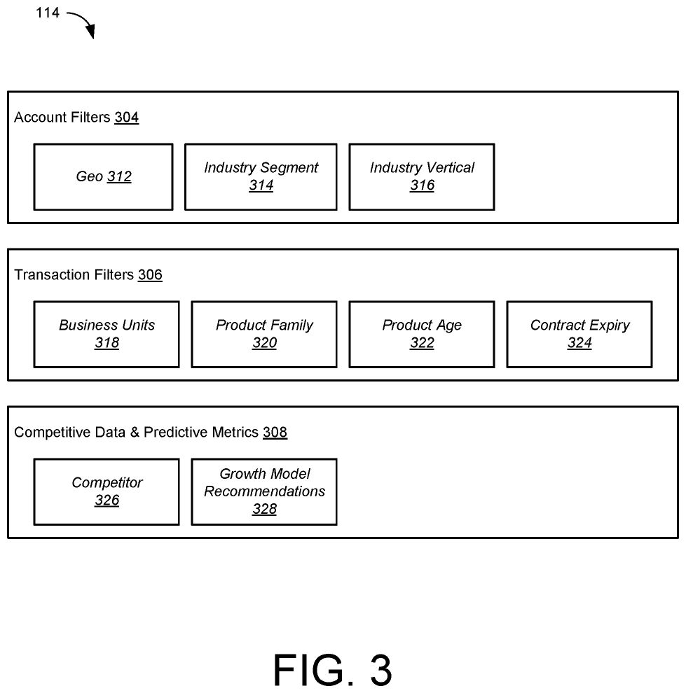

FIG. 3 shows an example business intelligence request 114 according to embodiments of the disclosed technology. Referring to FIG. 3, the example business intelligence request 114 may include user selections of a number of criteria. In the example of FIG. 3, the criteria include account filters 304, transaction filters 306, and competitive data and predictive metrics 308. While a number of criteria are described with reference to FIG. 3, it should be understood that other criteria may be specified by a user as part of a business intelligence request 114.

In FIG. 3, the example account filters 304 include a Geo filter 312, an Industry Segment filter 314, and an Industry Vertical filter 316. The Geo filter 312 may be used to limit the campaign to one or more geographic areas. The Industry Segment filter 314 may be used to limit the campaign to one or more industry segments. Example industry segments include enterprise, midmarket, public-sector, service provider, small and medium business (SMB), and the like. The Industry Vertical filter 316 may be used to limit the campaign to specified industry verticals. For example, the industry verticals may include financial services, health and life sciences, manufacturing and distribution, public-sector education, and the like.

In FIG. 3, the example transaction filters 306 include business units 318, product family 320, product age 322, and contract expiry 324. The business units filter 318 may be used to limit the campaign to specified business units. The product family filter 320 may be used to limit the campaign to particular product families. The product age filter 322 may be used to limit the campaign to products having a specified age or age range. This filter may for example allow a user to select vulnerable products which are aging, and due for renewal. The contract expiry filter 324 may be used to limit campaign to contracts expiring within a specified period.

In FIG. 3, the example competitive data and predictive metrics 308 include competitor 326 and growth model recommendations 328. The competitor field 326 may be used to limit the campaign to compete with particular competitors. The growth model recommendations field 328 may be used to specify predictive models, for example based on product level.

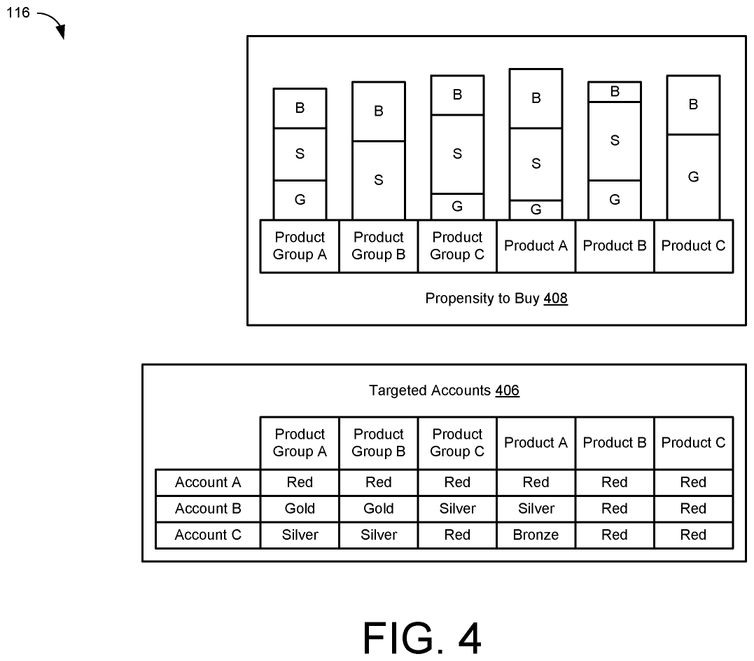

FIG. 4 shows an example predictive analytics view 116 according to embodiments of the disclosed technology. While a number of predictive analytics are described with reference to FIG. 4, it should be understood that other predictive analytics may be generated and displayed.

The predictive analytics view 116 may include a targeted accounts section 406. In the targeted accounts section 406, recommendations may be provided for each account by product group, product, and the like. The recommendations may be color-coded based on the strength and/or confidence level associated with each recommendation, for example using the colors gold, silver, bronze, and red, with the color gold representing the strongest recommendation.

The predictive analytics view 116 may include a propensity to buy section 408. The propensity to buy section 408 may include a graphic visual representation, e.g., a bar graph or the like, with each bar representing a product group, product, or the like. In an example bar graph visual representation, the height of each bar may represent a number of accounts likely to buy the product. Each bar may be broken into sections representing the recommendations, which as before may be color-coded based on the strength and/or confidence level associated with each recommendation, for example with the colors gold (G), silver (S), and bronze (B), with the color gold representing the strongest recommendation.

In addition, the predictive analytics view 116 can give recommendations by the Business Units (Bus). The predictive analytics may consider key factors for determining the recommendations. Such key factors may include, but are not limited to, revenue of the previous years, variety of purchases, frequency of purchase, employee size, company revenue, win rates in the past, visits to the corporate websites, etc. These models are built and deployed on selected big data platform such that the analytics functions can be performed at accelerated speed.

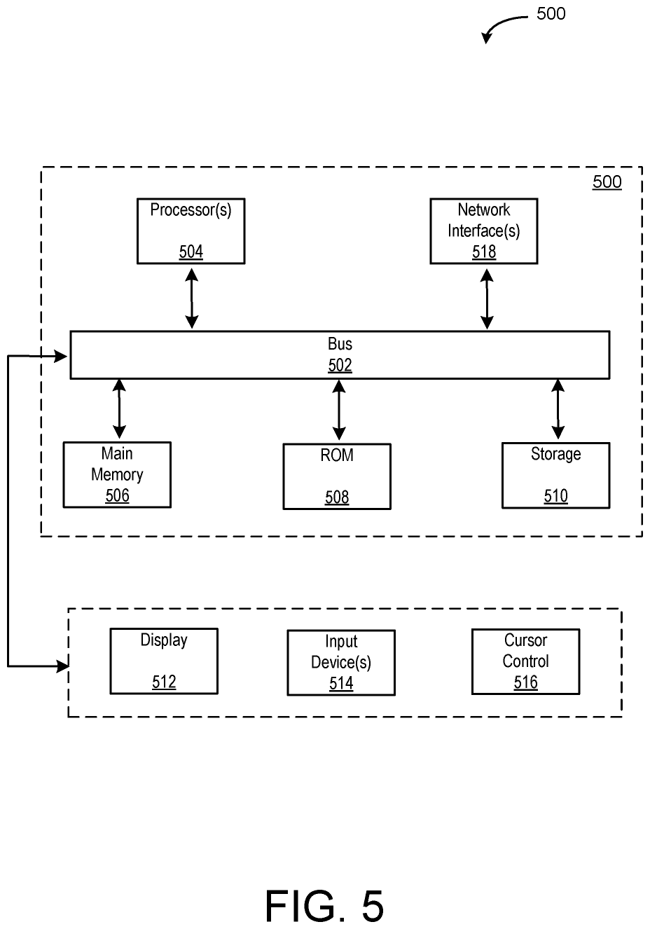

FIG. 5 depicts a block diagram of an example computer system 500 in which embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a liquid crystal display (LCD) (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. In some embodiments, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

The computer system 500 also includes a communication interface 518 coupled to bus 502. Network interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, network interface 518 may be a local area network (LAN) card to provide a data communication connection to a compatible LAN (or WAN component to communicated with a WAN). Wireless links may also be implemented. In any such implementation, network interface 518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 518, which carry the digital data to and from computer system 500, are example forms of transmission media.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system, comprising:
a hardware processor; and
a non-transitory machine-readable storage medium encoded with instructions executable by the hardware processor to perform a method comprising:
identifying a plurality of business intelligence data sources, wherein the business intelligence data sources are separate and diverse;
creating data tables in a database management system from the plurality of business intelligence data sources;
creating a unified data model from the data tables;
receiving a business intelligence request; and
responsive to the business intelligence request:
generating one or more predictive analytics based on the unified data model, and
displaying a view of the one or more predictive analytics.

2. The system of claim 1, further comprising:
optimizing the data tables, wherein the unified data model is created from the optimized the data tables.

3. The system of claim 1, further comprising:
refreshing the multiple business intelligence data sources according to a data mining system.

4. The system of claim 1, further comprising:
generating one or more predictive business intelligence analytics based on the unified data model and one or more user-supplied criteria.

5. The system of claim 1, further comprising:
creating the unified data model in a data visualization system.

6. The system of claim 5, further comprising:
displaying the view of the one or more predictive analytics in the data visualization system.

7. The system of claim 1, wherein:
the predictive analytics represent a propensity to buy of a customer.

8. A non-transitory machine-readable storage medium encoded with instructions executable by a hardware processor of a computing component, the machine-readable storage medium comprising instructions to cause the hardware processor to perform a method comprising:
identifying a plurality of business intelligence data sources;
creating data tables in a database management system from the plurality of business intelligence data sources, wherein the business intelligence data sources are separate and diverse;
creating a unified data model from the data tables;
receiving a business intelligence request; and
responsive to the business intelligence request:
generating one or more predictive analytics based on the unified data model, and
displaying a view of the one or more predictive analytics.

9. The medium of claim 8, further comprising:
optimizing the data tables, wherein the unified data model is created from the optimized the data tables.

10. The medium of claim 8, further comprising:
refreshing the multiple business intelligence data sources according to a data mining system.

11. The medium of claim 8, further comprising:
generating one or more predictive business intelligence analytics based on the unified data model and one or more user-supplied criteria.

12. The medium of claim 8, further comprising:
creating the unified data model in a data visualization system.

13. The medium of claim 12, further comprising:
displaying the view of the one or more predictive analytics in the data visualization system.

14. The medium of claim 8, wherein:
the predictive analytics represent a propensity to buy of a customer.

15. A method comprising:
identifying a plurality of business intelligence data sources;
creating data tables in a database management system from the plurality of business intelligence data sources, wherein the business intelligence data sources are separate and diverse;
creating a unified data model from the data tables;
receiving a business intelligence request; and
responsive to the business intelligence request:
generating one or more predictive analytics based on the unified data model, and
displaying a view of the one or more predictive analytics.

16. The method of claim 15, further comprising:
optimizing the data tables, wherein the unified data model is created from the optimized the data tables.

17. The method of claim 15, further comprising:
refreshing the multiple business intelligence data sources according to a data mining system.

18. The method of claim 15, further comprising:
generating one or more predictive business intelligence analytics based on the unified data model and one or more user-supplied criteria.

19. The method of claim 15, further comprising:
creating the unified data model in a data visualization system.

20. The method of claim 15, wherein:
the predictive analytics represent a propensity to buy of a customer.
